(19) United States
(12) Patent Application Publication
(10) Pub. No.: US 2004/0057697 A1
(43) Pub. Date: Mar. 25, 2004

(54) Streaming digital recording system

(76) Inventors: Peter Renzi, Acton, MA (US); Eddie Mitchell, Harvard, MA (US)

Correspondence Address: ROETZEL & ANDRESS, 1375 EAST 9TH STREET, CLEVELAND, OH, 44114, US

(21) Appl. No.: 10/665,277

(22) Filed: Sep. 19, 2003

Related U.S. Application Data
(60) Provisional application No. 60/411,947, filed on Sep. 19, 2002.

(51) Int. Cl. H04N 5/91

(52) U.S. Cl. 386/83

(57) ABSTRACT

A streaming digital recording system and method uses a video recorder object and first memory in combination with a streaming object to stream video data to a digital storage device from the first memory. Computer readable instructions of the streaming object are operative with the first memory to monitor the first memory for intermediate storage of image data recorded by a video recorder or other data recording device, and to stream the image data from the first memory to a digital or optical storage device. The streaming of video data to a digital storage device can be performed while the first memory continues to receive additional image data, resulting in rapid creation of digital image and video files. The system is also described for use in creating high resolution digital video records of medical and surgical procedures.

### RELATED APPLICATIONS

This application claims the benefit of U.S. Provisional Application No. 60/411,947, filed Sep. 19, 2002.

### FIELD OF THE INVENTION

The invention relates generally to the capture and management of images and video images associated with medical surgical procedures, and any other event and sequence of events recorded by an image or video or data recording device.

### BACKGROUND OF THE INVENTION

Video images recorded during a live event such as a surgical procedure, for example, have traditionally been recorded directly onto S-VHS analog tape. Analog tape provides a low quality representation of the procedure that makes viewing details of the video difficult during presentations and other viewing scenarios. Analog storage mediums also tend to decay over time, causing deterioration of the images recorded thereon.

To provide audience members with an enhanced version of the video and for documentation purposes, a post recording analog to digital conversion of the images can be performed to store the video images on a digital video recording medium. Dedicated digital recording devices are commercially available to perform this analog to digital conversion. However, these devices are costly and typically require a lengthy period of time, in addition to the time required for the analog recording process, to perform the conversion.

For these reasons, video images of surgical procedures are typically captured as a batch and initially saved to a magnetic storage device such as an internal disk drive found in most personal computers. Once the video image capturing process has been completed a post capture recording process is performed to write the batch of saved video images onto compact disc (“CD”) data storage media typically formatted as either CD-R or CD-RW. CDs are capable of storing video images at higher resolutions than S-VHS analog tapes, and images stored on CDs will endure for extended periods of time with minimal deterioration. Unlike S-VHS analog tapes, though, CDs have a relatively small capacity and can typically only store the equivalent of about 700 MB of video images. This amounts to approximately 10 to 15 minutes of recording time depending on the resolution of the video images.

More recently, digital recording devices have been developed to allow captured video images to be recorded onto Digital Versatile Discs, also commonly referred to as Digital Video Discs (“DVD”s). Similar to the system for storing video images on CDs described above, the video images must first be captured as a batch and written to a magnetic storage device, such as an internal disk drive of a computer, before being stored onto a DVD. Again, recording of the captured video images onto the DVD does not begin until all of the video images are saved to the internal disk drive. Thus, such a system requires post capture recording of the video images to a DVD. Due to the large storage capacity of DVDs, typically about 4.7 GB, the length of video images that can be stored thereon has been extended to about 60 to 120 minutes, depending on the desired quality of recording of the video images. But this large storage capacity of DVDs also means that the post capture recording time can take an hour or more to record a full-length surgical procedure onto a DVD. Current advances in DVD recording technology have shown an increase in the recording speed from 1× up to 4×. This has resulted in a decrease in recording time, as long as faster, more expensive DVD-R media is used.

Presently, systems exist for recording video images directly to optical storage mediums such as compact disks and DVDs. Such systems employ direct writing technology to record video images onto DVDs as they are captured and without first saving the video images to a preliminary storage device. Systems of this nature will not suffice to record video images of live events, such as surgical-procedures, where there is limited opportunity to capture the video images. Common occurrences such as exchanging a DVD filled to its capacity with a blank DVD, or the corruption of digital recording media, will cause potentially important video images to be omitted from the recording as the surgical-procedure or other live performance continues uninterrupted.

Accordingly, there is a need in the art for a low-cost system for recording high-quality video images that can be used to record a live event. The system should provide a high-quality recording of the video images on a portable storage medium while generally simultaneously storing at least a second recording of the video images on a backup video image storage medium. Further, the system should minimize the time required for a post capture recording process.

### SUMMARY OF THE INVENTION

It is an objective of the invention to minimize the high post-capture video recording time for writing video images onto a digital storage medium. It is a further object of the present invention to provide redundancy and data backup of video images to be saved onto the video image recording medium.

The present invention achieves these and other objectives by providing a computer-based capture and recording system that simultaneously captures video images of an event and saves the video images to a first storage medium while simultaneously writing the captured video images to a second storage medium as the video recording continues. Upon completion of recording of the event, a minimal period of time is required to finish writing the video images onto a second storage medium.

In accordance with one general aspect of the invention, there is provided a digital recording system including for example a video recorder controlled by a video recorder object, a first memory coupled to receive image data from the video recorder, and computer readable instructions or streaming object which controls the first memory for streaming of image data captured by the video recorder, the streaming object also controlling the streaming of the image data to the digital storage device after a streaming buffer delay.

In accordance with another aspect of the present invention, there is provided a digital recording system which includes a video recorder for capturing digital image data, a video recorder object which controls operations of the video recorder, and a memory controller in communication with the video recorder to receive the digital image data captured by the video recorder. The memory controller is further in communication with a first memory and an optical storage device, the memory controller having computer readable instructions to monitor the first memory for streaming of the digital image data captured by the video recorder, the computer readable instructions operable to stream digital image data from the first memory to the optical storage device after a streaming buffer delay.

Another aspect of the present invention is a method for producing digital video, including the steps of capturing image data of motion video data, still image data, audio data, subtitle data, caption data, of commentary data; saving captured image data to a first memory; monitoring the first memory with a streaming object; streaming the image data to a digital storage device; and writing the streaming image data to a recordable data storage medium with a digital storage device.

And in another aspect of the invention, there is provided a system for capturing a digital record of a surgical procedure which includes: a video recorder for recording digital image information of a surgical procedure; a first memory operative to receive and hold the digital image information recorded by the video recorder, and a streaming object which controls transfer of the digital image information from the first memory to a digital storage device.

These and other aspects of the invention are herein described in detail, with reference to certain preferred and alternate embodiments which are illustrative but not exclusive of various ways in which the principles and concepts of the invention can be embodied and practiced.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a system architecture of a digital recording system in accordance with the present invention; and

FIG. 2 is a schematic diagram of hardware and software components of a digital recording system in accordance with the present invention.

### DETAILED DESCRIPTION OF PREFERRED AND ALTERNATE EMBODIMENTS

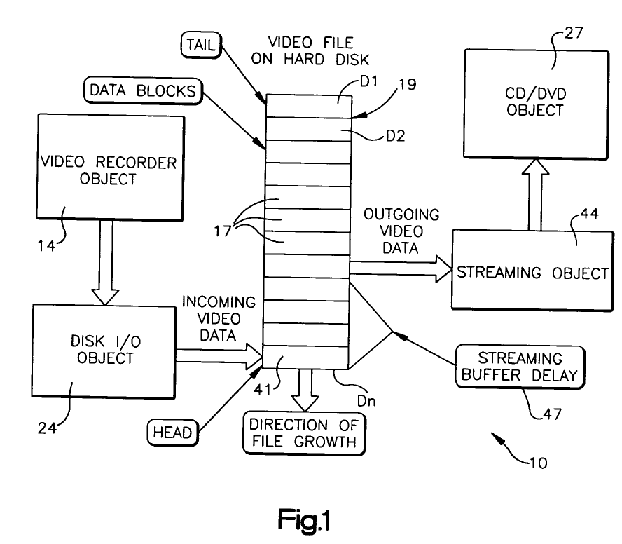

FIG. 1 is a block diagram of a streaming logical architecture of a digital recording system with streaming capability in accordance with one embodiment of the present invention. Image data is converted into electronic data by a video recording device, under the control of a video recorder object 14, to be communicated to other components of the recording system 10. The electronic data corresponding to the images is allocated into data blocks 17 that form a video file in a first memory 19 by operation of a disk input/output object 24, also referred to herein as a memory controller. While the electronic data corresponding to the observed images is being allocated into the data blocks 17, the electronic data stored in the data blocks 17 is generally simultaneously being delivered to a digital storage device 27 as data blocks by the streaming object 44 to be written as a high quality video image onto a recordable data storage medium (not shown). This type of electronic data processing and generally simultaneous storage process, is referred to herein generally as streaming or streaming of data, or, data streaming, as further described herein.

The video recorder is a device that accepts raw digital data or converts analog video data to digital video data from devices focused on objects or events to observe visible images and audible sounds in real-time and convert those observations into digital or other electronic signals. A video recorder device can be adapted to cooperate with surgical or other medical instruments to capture image data from within a patient, such as a fiber optic device that is capable of being inserted into a patient through cannulae that typically define an interior passage into the patient during endoscopic procedures. A light, microphone or other peripheral devices can be used in combination with video devices for capturing additional data as controlled by the video recorder object 14.

The video recorder object 14 controls and monitors all aspects of the video recorder device and is responsible for all video recording and display functions. A live video display presented by the video recorder object may be turned on or off. Additionally, the live video display may be switched from a windowed mode to a full screen mode. Prior to live video recording, the video recorder object issues commands, which establish the quality of the video to be recorded. In addition, the video recorder object is responsible for sending the commands, which start and stop video recording or initiate the capture of a still image. During the issuance of a ‘record’ or ‘still image capture’ command, a file name and storage location is provided, which defines where the video or picture file should be stored, and what it should be named. The video recording object provides for simultaneous capture of video and still images, without interruption of either process. The video recorder object is also responsible for monitoring the status of the video input signal. If a video signal is not present on the input to the video recorder device, the video recorder object presents warning messages to the user so the problem can be corrected.

Recording or storage of the image data, as distinguished from capturing the image data, is the writing or otherwise saving the captured image data to a digital data storage device, such as the recordable data storage medium, a magnetic storage medium, and any other object for storing electronic data. A preferred data storage medium for practicing the invention is an optical data storage medium that data can be written to, and retrieved from, by a laser-based encoder and a laser-based decoder, respectively. CDs and DVDs are two common examples of recordable data storage media. A network and a network connected storage device can also be used as the data storage medium.

Captured image data representing the images and sounds is formatted into a suitable format to allow reproduction of the images and sounds by conventional video reviewing equipment. The suitable formats include, but are not limited to, formats established by the Motion Picture Experts Group (“MPEG”) such as MPEG-2 and MPEG-4, as well as others that are based on standards such as Quicktime, Windows Media Video (WMV) and the like. Conventional video reviewing equipment of the sort used to view the images and sounds includes any device such as a television, computer, projector, handheld video device, printer, and any other device for reviewing visible images that can communicate with an optical data retrieval device. Video reviewing equipment that lacks means for playing the audible sounds captured by the video recorder 14 will reproduce the recorded images without the recorded audible sounds. Optical data retrieval devices are known for their ability to repeatedly reproduce high-quality video images based on the recorded image data. Such optical data retrieval devices include CD and DVD-ROM drives of digital computers as well as CD and DVD players commonly found in household entertainment systems, for example.

For the purposes of this submission, the phrase “high-quality”, when referring to video images, is defined as digitally recorded National Television Standards Committee (“NTSC”) video that at least meets the standards of a 6 Mb per second (6 Mbps) MPEG-2 recording, with a minimum pixel matrix of 640 (horizontal lines)×480 (vertical lines) at 30 frames per second. It follows, then, that high-quality, as used herein, also meets other standards such as, MPEG-4, Windows Media Video (WMV), digital video, and other standards. Digital video being image data represented by computer-readable binary numbers that describes a finite set of colors and luminance levels. Digital video standards apply for Phase Alternation Line (“PAL”) video.

Image data is captured and divided into manageable quantities, referred to as data blocks 17, to be stored. The disk I/O object/memory controller 24 controls the data blocks 17 into which the quantities of captured image data are stored into the first memory 19 during the recording of the image data. Thus, the order in which the captured image data is saved is also controlled by the memory controller 24. In a preferred embodiment of the invention, the captured image data is recorded as a video file in the first memory sequentially, in the chronological order in which it was captured. When the video recorder object 14 receive a request to begin recording video, it issues a request to the disk I/O object 24 to create a video file in first memory 19. The initial creation point of the video file on the hard disk becomes the “TAIL” as indicated, which contains the oldest video data. When this startup sequence is completed, the video recorder object 14 begins capturing and encoding video frames. Encoded video frames are submitted to the disk input/output object 24 for writing to the file in the first memory (hard disk) 19. The disk I/O object 24 always writes data into the file sequentially, causing the video file to grow dynamically in the DIRECTION OF FILE GROWTH as long as video recording is active.

A quantity of image data is captured and saved into the first memory 19 starting with an initial data block D1 in the first memory 19. A subsequently captured quantity of image data is thereafter recorded in a similar fashion in a second data block D2, which is incrementally closer to a terminal end Dn of the video file than the initial data block D1. This trend continues as each subsequently captured quantity of image data is acquired by the video recorder 14, until the final quantity of captured image data is stored into a data block 41 at, or adjacent to, the terminal end Dn of the video file. According to this method of recording the image data to the first memory 19, the terminal end Dn of the video file is extended further from the initial data block D1 as each subsequent quantity of image data is saved into the first memory 19. Captured image data recorded in this manner can be retrieved from the first memory 19 in order from the initial data block D1 to the terminal data block Dn and without dedicated means for assigning and documenting the location of the data blocks 17 in which the image data was stored in the first memory 19.

The recording of captured image data into the first memory 19 in the order in which it was captured as described above allows the recorded image data to be sequentially read from the first memory 19 in the same order. Image data is read from the first memory 19 starting with the image data recorded in the initial data block D1, followed by the image data recorded in the second data block D2, and so on until the image data is retrieved from the terminal data block Dn. The disk I/O object 24 always writes data sequentially into the video file in first memory 19, so that the video file grows dynamically as long as video recording is occurring. In this manner, the order in which the video images were captured by the video recorder object 14 is maintained as the image data is read from the first memory 19.

Although chronological recording of image data in the first memory 19 is described above, storing the image data in randomly selected data blocks 17 in the first memory 19, or in any order other than chronological is also within the scope of the present invention. When one of these alternative orders of recording image data in the first memory 19 is employed, the memory controller 24 must further include a read/write pointer, a counter, or other means for documenting the order of the data blocks in which the image data is recorded into the first memory 19. The read/write pointer, counter, or other means for documenting the order of stored data in the first memory 19 will allow the stored image data to be sequentially read from the first memory 19 in the order that the image data was captured. Thus, in the case where the captured image data represents a motion picture, the image data is read from the first memory 19 in the order that each frame of the motion picture was captured.

The first memory 19, in one embodiment, is preferably a magnetic storage device, commonly referred to as a hard disk. Hard disks are well known in the art and are typically, but not always, disposed internally of digital computers to store data, instructions to control the interaction of the various components of digital computers, and a variety of other types of information. The first memory 19, according to another embodiment of the present invention can include data storage means such as random access memory (“RAM”), or any other type of volatile memory that minimizes the time required for recording image data therein and/or reading image data therefrom. Further embodiments can also include a first memory that is an electronically eraseable, programmable read only memory (“EEPROM”) that is well known to include features of both a volatile memory such as RAM, and nonvolatile memory such as the hard disk. The recording device 14 can also have any of the types of memory of the first memory device 19.

Streaming of the data, or data streaming, as used herein refers generally to the manner in which image data representing audio, video, any associated captions or commentary, and any other items captured by the video recorder 14 is transferred from the first memory 19 to the digital storage device 27. In streaming the image data to the storage device 27, the image data does not have to be delivered to, or present at the storage device 27 in its entirety for the storage device 27 to begin writing the image data onto the recordable data storage medium. As described, when an initial quantity of image data. e.g. in the form of a data block D, is delivered to the storage device 27, the storage device 27 commences writing of the delivered image data onto the recordable data storage medium, and writing continues as additional image data is delivered. The streaming of data to the storage device is thus not interrupted by acquisition of additional image data and input to the first memory 19. Furthermore, the system is capable of simultaneously streaming data to the storage device 27 and capturing and storing new video data in first memory 19.

The streaming object 44 is provided to effectuate the transmission of image data recorded into the first memory 19 to be written onto the recordable data storage medium by the digital storage device 27. The streaming object 44 can be a set of computer readable instructions operative with the first memory 19 and embodied in software that is accessible from the first memory 19. The streaming object can also be computer readable instructions embodied in firmware. The streaming object 44 monitors the creation and growth of the video file, beginning with the TAIL or last saved data block D and opens the file for reading once a minimum presselected number of data blocks are available for reading from the video file 19. The minimum number of bytes is referred to as the streaming buffer delay 47.

The streaming buffer delay is important to smooth operation of the streaming object 44, because low-level I/O activity too close to the head of the video file can cause destination file corruption, which occurs if data is read prior to final commitment by the disk I/O object and operating system. Each time the streaming object 44 is ready to read a block of data D from the video file, it first checks to guarantee that the minimum number of bytes is equal or greater than the specified streaming buffer delay. If available, a block of data D is read from the video file and written to the target media by the recording device 27.

Free space is checked on the CD or DVD media at the beginning of each streaming session. This information is combined with continuously monitored video file sizes on the hard disk (first memory 19), to produce an indication of free space remaining on the CD or DVD media. This very important because monitoring of the free space on the media during a streaming session could cause an under-run condition, resulting in data loss. Disk space information is used to automatically stop recording when the CD or DVD is filled to capacity.

Under normal system usage conditions, users are required to insert streaming DVD or CD media into the drive of the digital storage device 27 at the beginning of use of the system. If video recording is initiated prior to inserting media, an audible and/or visual warning is presented to the user. Video is still recorded to the hard disk (first memory 19) during this time. The system will automatically attempt to initiate streaming each time video recording is started. Therefore, an operator may insert media into the system, stop video recording, and then restart video recording to restart streaming mode. Once streaming mode has been initiated, the system will proceed to stream all available video files from the hard disk (first memory 19) to the recording device CD or DVD, beginning with the first unsaved video file, and automatically proceeding to stream all available video files from the first memory.

Similarly, at the beginning of a new video recording, or when streaming is initiated, video files are verified between the first and second memories/storage devices. If a partially streamed video file is detected, streaming will be initiated on that file, beginning with the first data block that was not previously transferred from the first memory to the digital storage device.

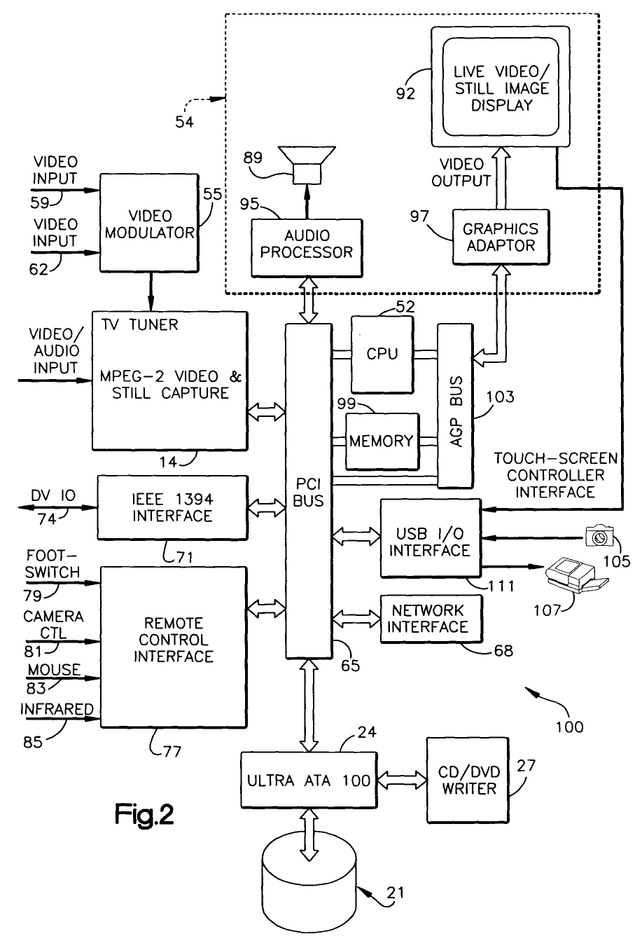

As shown in FIG. 2, a processing unit/CPU 52 performs tasks based on the instructions to control and monitor the components of the recording system. Prior to streaming data to the recording device 27, the streaming object 44 performs a check to ensure that the appropriate recordable data storage medium is available to have the image data recorded thereon. The appropriate image data storage medium is determined based on criteria such as the type of video reviewing device that will be used to review the recorded video images, the desired format of the recorded image data, the desired recording time, and the desired quality of the video images upon being reviewed.

If a problem with the recordable data storage medium is detected by the streaming object 44, at least one of a visual or audible notification is provided. Examples of problems associated with the recordable data storage medium include a defective recordable data storage medium, the absence of a recordable data storage medium, an insufficient amount of available capacity on the recordable data storage medium, the recordable data storage medium as an unformatted CD, or any other problem pertaining to the recordable data storage medium that would prevent the recording of image data thereon. In the case where an unformatted CD is the recordable data storage medium, the notification will be provided and the CD formatted according to externally input instructions. In the case of a DVD with an unsuitable format in the recordable data storage medium, an alert is generated and streaming of the image data to the recording device 27 is halted until a suitable recordable data storage medium provided.

Once the presence of the appropriate data storage medium has been verified, the streaming object 44 monitors the recording of the video file into the first memory 19. After a predetermined number of data blocks 17 have a quantity of image data saved therein, the streaming object 44 begins to stream the image data to the digital storage device 27. For example, the streaming object 44 monitors the first memory 19 until image data has been recorded into four data blocks 17. As the memory controller 24 saves image data into the fifth data block 17 following the recording of the image data in the initial data block D1, the streaming object 44 delivers the image data in the initial data block D1 to the digital storage device 27 to be written onto the recordable data storage medium. Delivery of the image data to the digital storage device 27 continues in a generally continuous manner and simultaneously with the recording of captured image data to the data blocks 17 of the first memory 19. However, image data is delivered from data blocks 17 following a streaming buffer delay 47 where captured image data is recorded in four subsequent data blocks 17.

As mentioned above, streaming object 44 causes the image data recorded in the first memory 19 to be streamed to the storage device 27 in a generally continuous fashion. Delivery of the image data to the storage device 27 follows the streaming buffer delay 47 and begins with the image data recorded in the initial data block D1. This is followed by the delivery of the subsequently recorded image data saved in the second data block D2 that is incrementally closer to the terminal end Dn of the video file. This process continues until the image data saved in the terminal data block Dn at the end of the video file is delivered to the storage device 27. Thus, the quantities of image data are delivered to the storage device 27 in the same order that they were recorded in the data blocks 17 of the first memory 19. Therefore, the order in which the image data was captured by the video recorder 14 is maintained.

The writing of the image data onto the recordable data storage medium lags the recording of the image data in the first memory 19 by the streaming buffer delay 47. This generally simultaneous recording process provides an image data backup in the event one of the first memory 19 and the storage device 27 malfunctions. However, the invention includes systems wherein the captured image data is recorded in the first memory 19 and on the recordable data storage medium without the streaming buffer delay 47.

Free space remaining on the recordable data storage medium is monitored, as described previously, while image data is written thereon. The information obtained during the monitoring of free space on the recordable data storage medium will automatically interrupt the data streaming to the digital storage device 27 in the event that the recordable data storage medium is filled to capacity. Such an interruption will exist until the recordable data storage medium is replaced with a blank recordable data storage medium. When the filled recordable data storage medium is replaced, data streaming will resume. During the interruption, the recording of captured image data in the first memory continues.

The recording interruption described above can cause the streaming buffer delay 47 to be increased by the amount of time required to replace the filled recordable data storage medium. A plurality of recording devices 27 can be provided to record image data to a plurality of recordable data storage media. When a first recordable data storage medium is filled to capacity, a second recording device 27 records the image data to a second recordable data storage media with a minimal interruption.

In use, the system illustrated in FIG. 1 captures video and still images, as well as audible sounds as image data as controlled by the video recorder object 14, which converts the image data as digital signals as part of the capturing process. The captured image data is recorded in the first memory such that the order in which the image data was captured is maintained when the image data is read from the first memory 19. Streaming object 44 monitors the recording of image data in the first memory 19 and determines the presence and format of the recordable data storage medium in the digital storage device 27. In the absence of a problem associated with the recordable data storage medium, the streaming object 44 streams image data to the storage device 27 substantially simultaneously and in a generally continuous manner following the streaming buffer delay 47. Image data streamed to the storage device is written onto the recordable data storage medium as it arrives at the storage device 27, regardless of whether the entire video file has been delivered to the storage device 27.

Once captured, the image data is encoded and compressed into a digital format, for example, to maximize the quality of image data that can be written into the video file 19 in the first memory 19, and to maximize the quality of the image data saved on the recordable data storage medium. If desired, the compressed data can be transcoded to another compressed format before being saved into the video file and the recordable data storage medium.

The streaming object 44 can differentiate between a CD and a DVD in the digital storage device 27. When a CD is detected in the recording device 27, a notification is provided to identify the recordable data storage medium as a CD. Following the notification, the CD is formatted to a suitable format for recording the captured image data. The suitable format can be any format typically used to record video images and sounds. In an alternate embodiment of the system, data from the video recorder 14 is split to write to magnetic and optical media at the same time.

FIG. 2 is also representative of an example of a recording system in accordance with the present invention which can be used in a medical environment for creating a digital image record of a surgical or other medical procedure. In addition to the items described above, this system further includes image data presentation equipment 54 for providing a real-time audio and video playback of the events and objects being captured by the video recorder, and an array of peripheral devices to permit a surgeon or other medical technician to control the operation of the recording system during a medical procedure. It is understood, however, that the present invention can also be provided with any other types of peripheral devices, as needed, to adapt the recording system for use in any specified environment.

Video modulator 55 is equipped with a plurality of video inputs 59, 62 to support the capture of image data from more than just the video recorder input 14. Image data input to the recording system 100 by way of the video modulator 55 is communicated first to the video recorder, and then onto a data bus 65. From the data bus 65, the image data can be transmitted to be recorded in the first memory 19 and/or on the recordable data storage medium, displayed by the image data presentation equipment 54, transmitted to a perhipheral device, and transmitted to a network 68 in communication with the recording system 10. The system will record one video input at a time. Any of the inputs may be selected (while recording is active), either direct from the recording/capture device, or from the video modulator, or other video switching device.

Similarly, a digital video interface 71 having a bi-directional data path 74 can be disposed to communicate with the data bus 65 to capture image data from digital video equipped video devices (not shown). Again, the image data captured by the digital video interface is transmitted to the data bus 65, however, image data can be transmitted from the data bus 65 to be reviewed with the digital video enabled video recorder due to the bi-directional data path 74. According to an embodiment of the present invention, the digital interface can be an IEEE 1394 Digital Video Interface, a Serial Digital Interface (SDI), or other such digital video interfaces.

The recording system 100 can be remotely operated by a party away from the location of the event or object where the image data is being captured, and by a party at the event or object whose hands are occupied. A remote control interface 77 with a plurality of inputs 79, 81, 83, 85 is provided for communication with devices such as a foot-switch, camera control, microscope physician control, endoscopic camera physician control, mouse, touchpad, keypad, and an infrared controller (none shown). Signals transmitted by the aforementioned devices are modulated by the remote control interface 77, which, in turn, performs an appropriate control operation based on the signal.

The image data presentation equipment 54 for providing audio and video playback of the image data as it is being captured and/or recorded includes at least one of a speaker 89 and a display 92. Audio processor 95 is disposed to translate suitably formatted image data into an audio signal that is modulated by the speaker 89 to emit audible sounds. As previously mentioned, the audible sounds may be audio recordings alone, audio accompanying a motion video image, commentary accompanying at least one of a still image and a motion video image, sound effects, and any other audible sound.

Graphics adaptor 97 is provided to transmit image data as a suitably formatted signal to be displayed on display 92. Captured image data is delivered by the data bus 65 to a second memory 99, from where it is transmitted to the graphics adaptor 97 by a graphic data bus 103. The set of computer readable instructions to control streaming of image data to the recording device can be recorded in the second memory 99 for that purpose. Instructions for controlling the playback of sounds and images during the recording process can also be recorded in the second memory 99, as well as any other data, information and instructions for the operation of the recording system 100.

Display 92 can be any device known to display visible images from image data. It can be a conventional cathode ray tube display; a flat panel display based on plasma, liquid crystal, active matrix, and any other flat panel technology; a projector for displaying the image data over a large surface to be viewed by a sizeable audience; and any other type of display. A touchpad, keyboard, remote control, and other user interfaces (not shown) can be provided to allow instructions concerning the operation of the display to be input. This, and other peripheral devices such as a digital camera 105 and a printer 107, for example, are operatively connected to the recording system 100 at an input/output interface 111. According to the illustrative embodiment, the input/output interface 111 can capture digital image data at a higher resolution than can be captured from the video recorder 14. Further, the input/output interface 111 can support connections (not shown) to display image data in a variety of formats including S-video, VGA, digital video interactive, and the like.

The streaming digital recording system of the invention as described provides the benefits of: simultaneous recording or video to hard disk and optical media; copies of procedures on a hard disk from which additional copies can be made onto other media or viewing of historical records; no delay of procedures or recording due to any problems with or absence of a specific piece of optical media as a result of the use of the hard disk as an intermediate memory, also serving as a built-in recovery mechanism; a procedure recording closing time of approximately 3 minutes on average, versus 30 to 45 minutes for other recording devices, which employ the post-procedure recording technique, and much longer for analog VHS tape recording (this allows physicians to leave the operating room with a copy of the procedure in hand, and rapid preparation of the system for the next procedure). These and other advantages are achieved by the system as described and claimed herein.

What is claimed as the invention is:

1. A digital recording system comprising:
a video recording device to receive and encode video image data;
a video recorder object which controls and monitors operations of the video recording device;
a first memory for receiving image data from the video recording device;
a streaming object operative to stream the image data from the first memory to a digital storage device.

2. The digital recording system of claim 1 wherein image data is streamed to the digital storage device by the streaming object in the order in which the image data was received by the first memory.

3. The digital recording system of claim 1 wherein initial image data received by the first memory from the video recorder is streamed to the digital storage device by the streaming object while subsequent acquired image data is received by the first memory from the video recorder.

4. The digital recording system of claim 1 wherein image data is received by the first memory during a streaming buffer delay during which image data is not streamed to the digital storage device.

5. The digital recording system of claim 1 wherein image data is streamed to the digital storage device by the streaming object while the first memory is not receiving image data from the video recorder.

6. The digital recording system of claim 1 wherein the image data is received by the first memory as data blocks.

7. The digital recording system of claim 6 wherein the data blocks are encoded video frames.

8. The digital recording system of claim 1 wherein the streaming object is operative to check available storage space in the digital storage device prior to streaming image data to the digital storage device.

9. The digital recording system of claim 1 wherein the video recorder captures image data as one or more standards consisting of the group of MPEG-2, MPEG-4, WMV, and digital video.

10. The digital recording system of claim 1 further comprising a memory controller to control the recording of image data in the first memory.

11. The digital recording system of claim 1, wherein the first memory comprises random access memory.

12. The digital recording system of claim 1 wherein the first memory comprises a hard disk.

13. The digital recording system of claim 6 wherein the hard disk has a minimum rotational speed of 7200 RPM and a minimum bus speed of 100 MByte per second.

14. The digital recording system of claim, 1 wherein the digital storage device is an optical storage device.

15. The digital recording system of claim 14 wherein the optical recording device is one of a compact disk (CD) storage device and a digital video disk (DVD) storage device.

16. The digital recording system of claim 1, wherein the digital storage device is one of a network and network connected storage device.

17. The digital recording system of claim 1 wherein the streaming object is embodied in software.

18. The digital recording system of claim 1, wherein the streaming object is embodied in firmware.

19. A digital recording system, comprising:
a video recorder for recording image data;
a first memory for receiving image data from the video recorder;
a streaming object operative to monitor the first memory for storing the image data recorded by the video recorder, and to stream the image data from the first memory to a digital storage device after a streaming buffer delay.

20. The digital recording system of claim 19 wherein the streaming buffer delay is a minimum number of image data blocks of image data stored in the first memory.

21. The digital recording system of claim 19 wherein the streaming object is operative to stream image data to the digital storage device while the first memory receives image data from the video recorder.

22. The digital recording system of claim 19 wherein the first memory receives image data from the video recording during a streaming buffer delay.

23. The digital recording system of claim 19 wherein the first memory is a hard disk having a minimum rotational speed of 7200 RPM and a minimum bus speed of 100 MByte per second, and image data is stored as an encoded video file on the hard disk.

24. The digital recording system of claim 19 wherein the digital storage device is one of the group consisting of a compact disk (CD) storage device and a digital video disk (DVD) storage device.

25. The digital recording system of claim 19, wherein the streaming object is embodied in software, firmware or both.

26. The digital recording system of claim 19 wherein the digital storage device is at least one of a network, a hard disk, or random access memory.

27. The digital recording system of claim 19 wherein image data is stored in the first as data blocks of encoded video frame in an order received from the video recorder.

28. The digital recording system of claim 19 wherein the streaming object streams image data to the digital storage device in an order in which the image data was stored in the first memory.

29. The digital recording system of claim 19 wherein the streaming object is operative to check available storage space in the digital storage device prior to streaming image data from the first memory to the digital storage device.

30. A method for producing digital image video comprising the steps of:
recording image data by one or more recording devices controlled by a video recorder object;
storing recorded image data to a first memory;
monitoring the first memory with a streaming object which also controls streaming the image data to a digital storage device; and
writing the streaming image data to a recordable data storage medium in the digital storage device.

31. The method of claim 30 further comprising the step of formatting recorded image data to a compressed digital format.

32. The method of claim 30 further comprising the step of transcoding the recorded image data from one compressed format to another.

33. The method of claim 30 further comprising the step of waiting for a streaming buffer delay period before writing the image data to recordable data storage medium in the digital storage device.

34. The method of claim 30 further comprising the step of verifying that the digital storage device includes a recordable data storage medium prior to streaming image data to the digital storage device.

35. The method of claim 30 further comprising the step of sending visual and audible notification to a user if a problem is with the digital storage device is detected by the streaming object.

36. The method of claim 30 further comprising the step of determining whether the recordable data storage medium is a compact disk (CD) or a digital video disk (DVD), and notifying a user accordingly.

37. The method of claim 30 further comprising the step of formatting the recordable data storage medium.

38. The method of claim 37 further comprising the step of determining a format state of the recordable data storage medium if the recordable data storage medium is determined to be a digital video disk, and streaming image data if the recordable data storage medium is pre-formatted.

39. The method of claim 30 further comprising the step of verifying that there is enough free space available on the recordable data storage medium for saving image data.

40. The method of claim 30 further comprising the step of stopping recording image data when the recordable data storage medium in the digital storage device is filled to capacity.

41. The method of claim 40 further comprising the step of generating a notification when the recordable data storage medium in the recording device is full.

42. The method of claim 20 further comprising the step of storing recorded image data to the first memory while streaming image data to the digital storage device.

43. A computer-readable medium of instructions, comprising
means for recording and formatting digital image data;
means for storing captured digital image data in a first memory;
means for monitoring the first memory with a streaming object, the streaming object producing streaming data; and
means for writing the streaming data to an optical recording device to be written onto an optical data storage medium by the optical storage device.

44. The computer-readable medium of instructions of claim 43 wherein the means for recording further comprises means for encoding the digital image data.

45. The computer-readable medium of instructions of claim 43, wherein the streaming object comprises means for creating a streaming buffer delay before producing the streaming data for writing by the optical storage device.

46. A system for capturing a digital record of a surgical procedure the system comprising:
a video recorder for recording digital image information of a surgical procedure;
a video recorder object for controlling digital image data acquisition functions of the video recorder;
a first memory operative to receive and hold the digital image information recorded by the video recorder, and
a streaming object which controls transfer of the digital image information from the first memory to a digital storage device.

47. The system of claim 46 operative to stream digital image data to the digital storage device from the first memory while additional digital image data is received by the first memory.

48. The system of claim 46 operative to hold digital image information in the first memory during a streaming buffer delay before transfer to the digital storage device.

49. The system of claim 46 operative to receive additional digital image information in the first memory during a streaming buffer delay controlled by the streaming object.

50. The system of claim 46 operative to receive additional digital image information in the first memory while previous digital image information received and held by the first memory is transferred to the digital storage device by the streaming object.

51. The system of claim 46 wherein the first memory is a computer hard disk.

52. The system of claim 46 wherein the digital storage device comprises optically recordable storage medium for producing a digital record of a surgical procedure.
